(19) United States
(12) Patent Application Publication
(10) Pub. No.: US 2025/0258647 A1
(43) Pub. Date: Aug. 14, 2025

(54) OPTIMIZED WEIGHT, ACTIVATION, AND TILE SHUFFLING FOR HYPERDIMENSIONAL COMPUTING IN ANALOG IN-MEMORY COMPUTING

(71) Applicant: International Business Machines Corporation, Armonk, NY (US)

(72) Inventors: Charles Mackin, San Jose, CA (US); Nanbo Gong, White Plains, NY (US); Steven Holmes, Red Hook, NY (US)

(21) Appl. No.: 18/438,721

(22) Filed: Feb. 12, 2024

(51) Int. Cl. G06F 7/491

(52) U.S. Cl. CPC G06F 7/4915

(57) ABSTRACT

A computer-implemented method is provided which includes receiving array information associated with a processing core, the processing core including a plurality of tiles configured for performing one or more multiply-accumulate (MAC) operations. The method includes indexing the tiles, rows of the tiles, or both according to one or more metrics. The method includes performing an ordering based on the one or more metrics, where the ordering includes at least one of: an ordering of weights respectively associated with the rows; and an ordering of weights respectively associated with the tiles.

### BACKGROUND

The present disclosure generally relates to analog in-memory computing, and more specifically, to weight, activation, and tile shuffling for hyperdimensional computing in analog in-memory computing.

### SUMMARY

Embodiments of the present disclosure are directed to computer-implemented methods for. According to an aspect, a computer-implemented method includes receiving array information associated with a processing core, the processing core including a plurality of tiles configured for performing one or more multiply-accumulate (MAC) operations. The method also includes indexing the tiles, rows of the tiles, or both according to one or more metrics. The method also includes performing an ordering based on the one or more metrics, wherein the ordering includes at least one of: an ordering of weights respectively associated with the rows; and an ordering of weights respectively associated with the tiles.

Embodiments also include a computing system having a memory having computer readable instructions and one or more processors for executing the computer readable instructions. The computer readable instructions controlling the one or more processors to perform operations that include receiving array information associated with a processing core, the processing core including a plurality of tiles configured for performing one or more MAC operations. The operations also include indexing the tiles, rows of the tiles, or both according to one or more metrics. The operations also include performing an ordering based on the one or more metrics, wherein the ordering includes at least one of: an ordering of weights respectively associated with the rows; and an ordering of weights respectively associated with the tiles.

Embodiments also include a computer program product having a computer readable storage medium having program instructions embodied therewith. The program instructions executable by a processor to cause the processor to perform operations that include receiving array information associated with a processing core, the processing core including a plurality of tiles configured for performing one or more MAC operations. The operations also include indexing the tiles, rows of the tiles, or both according to one or more metrics. The operations also include performing an ordering based on the one or more metrics, wherein the ordering includes at least one of: an ordering of weights respectively associated with the rows; and an ordering of weights respectively associated with the tiles.

Other embodiments of the present invention implement features of the above-described method in computer systems and computer program products.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 illustrate a block diagram of an example computer system for use in conjunction with one or more embodiments of the present disclosure.

FIGS. 2A through 2D illustrate block diagrams that support optimized weight, activation, and tile mapping for hyperdimensional computing (HDC) in analog in-memory computing (AIMC) in accordance with one or more embodiments of the present disclosure.

FIG. 3 illustrates example flowcharts in accordance with one or more embodiments of the present disclosure.

FIG. 4 is a diagram illustrating an example structure of a core prior to ordering and an example structure of the resulting core, in accordance with example aspects of the present disclosure.

FIG. 5A is a diagram illustrating an example unsorted weight matrix of a core based on row ordering and/or tile ordering in accordance with example aspects of the present disclosure.

FIGS. 5B through 5E are diagrams illustrating examples of a sorted weight matrix based on row ordering and/or tile ordering in accordance with example aspects of the present disclosure.

FIG. 6 illustrates an example flowchart of a method in accordance with one or more embodiments of the present disclosure.

### DETAILED DESCRIPTION

Some computationally expensive operations may include encoding operations and classification operations (e.g., associated with an artificial neural network). Some approaches include using analog in-memory computing (AIMC) to accelerate such computationally expensive operations. In some cases, analog in-memory computing may enable multiply-accumulate (MAC) operations. MAC operations include fundamental calculations used in artificial intelligence (AI).

Hyperdimensional computing (HDC) is computational framework in which information is represented as a hyperdimensional (long) vector, an array of numbers. For example, some approaches employ HDC for machine learning tasks such as, for example, machine learning and classification. In some cases, HDC vectors and matrices are very large by definition, and effectively implementing HDC may be dependent on using many AIMC tiles.

According to one or more embodiments of the present disclosure, systems and techniques described herein that support the reshuffling of weights, activations, and/or tiles to improve computing of HDC vectors and matrices. The systems and techniques described herein include achieving a hardware implementation of HDC in AIMC. Examples of the techniques include shuffling of row/columns in support of early termination (e.g., variable precision HDC) and improved energy efficiency/throughput, shuffling of rows/activations in support of balancing tile currents (also applicable for variable precision HDC), and shuffling of tiles in support of early termination, detailed aspects of which will be described herein.

In exemplary embodiments, systems, methods, and computer program products are described which support the reordering of rows and MAC tiles to more evenly distribute computation/currents along analog tiles and enable early compute termination for variable accuracy. Advantages achievable based on the reordering may include variable precision, improved accuracy, improved throughput, and increased energy efficiency. Detailed descriptions of the systems, methods, and computer program products will be described herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as weight, activation, and tile shuffling for HDC in AIMC deployed on the block 150. Block 150 supports aspects of row ordering, tile ordering, and simulation described herein. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 135), and network module 115. Remote server 104 includes remote database 132. Public Cloud 105 includes gateway 130, Cloud orchestration module 131, host physical machine set 142, virtual machine set 143, and container set 144.

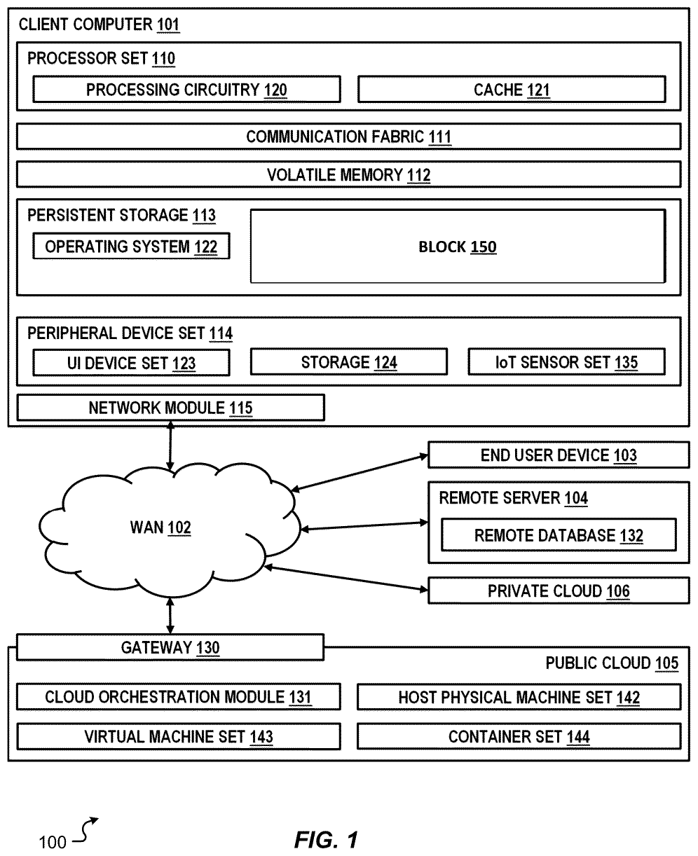

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

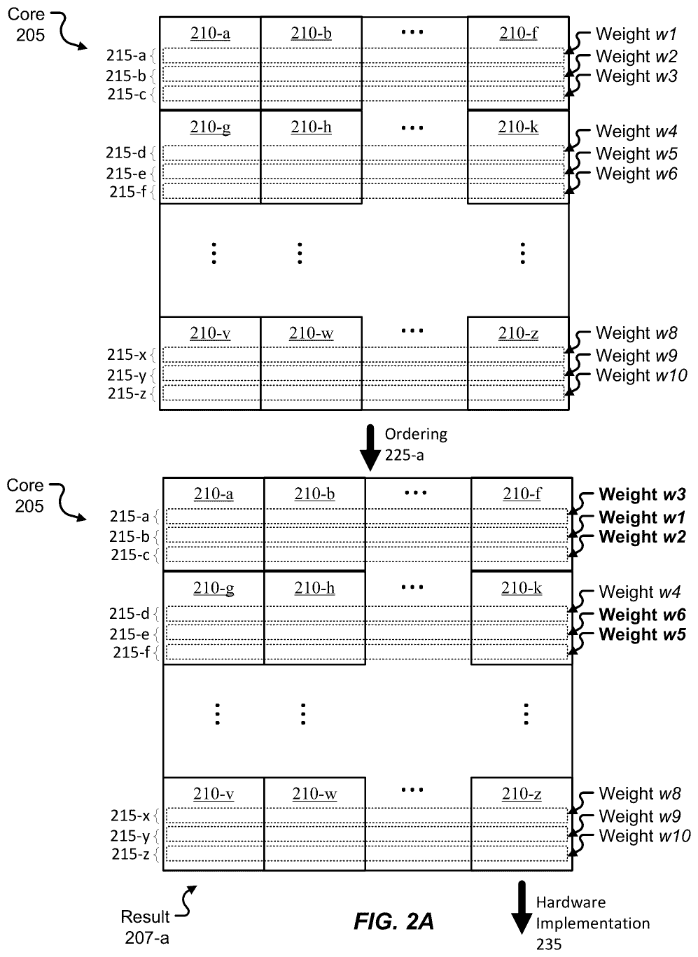

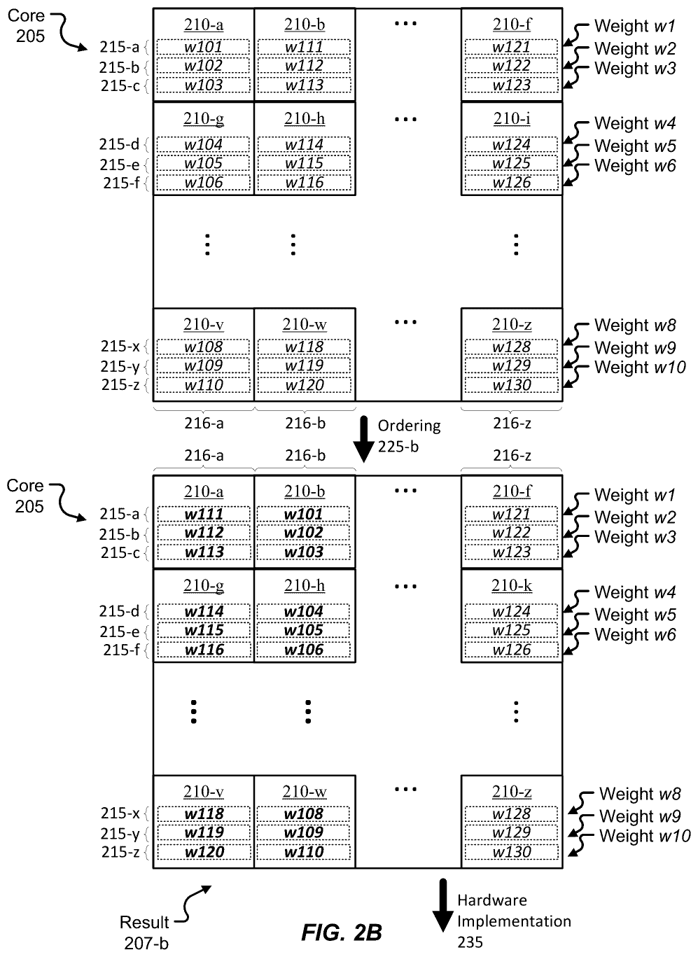

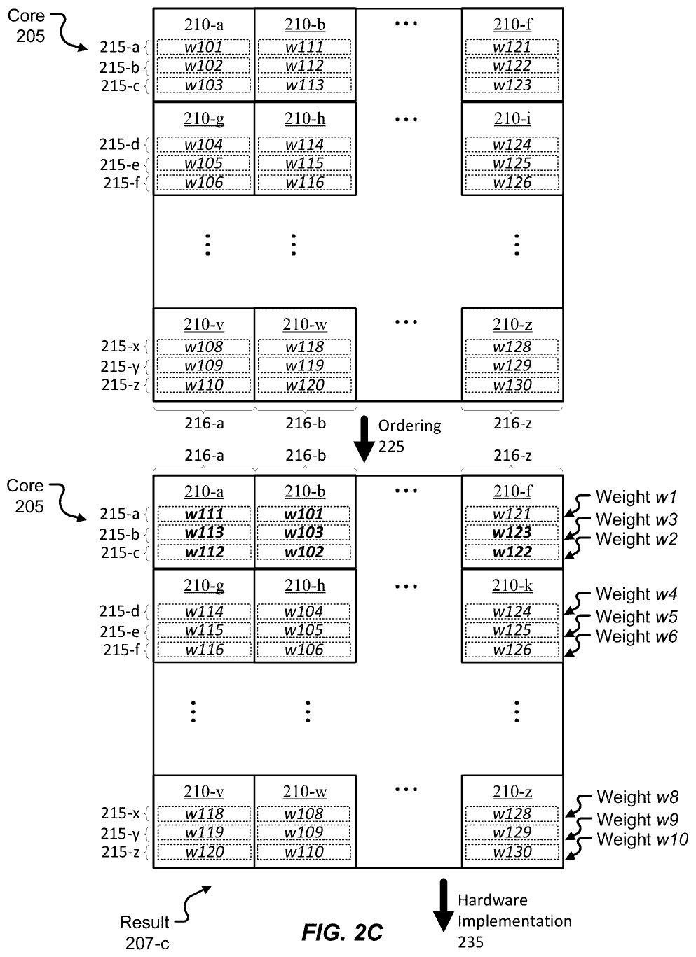

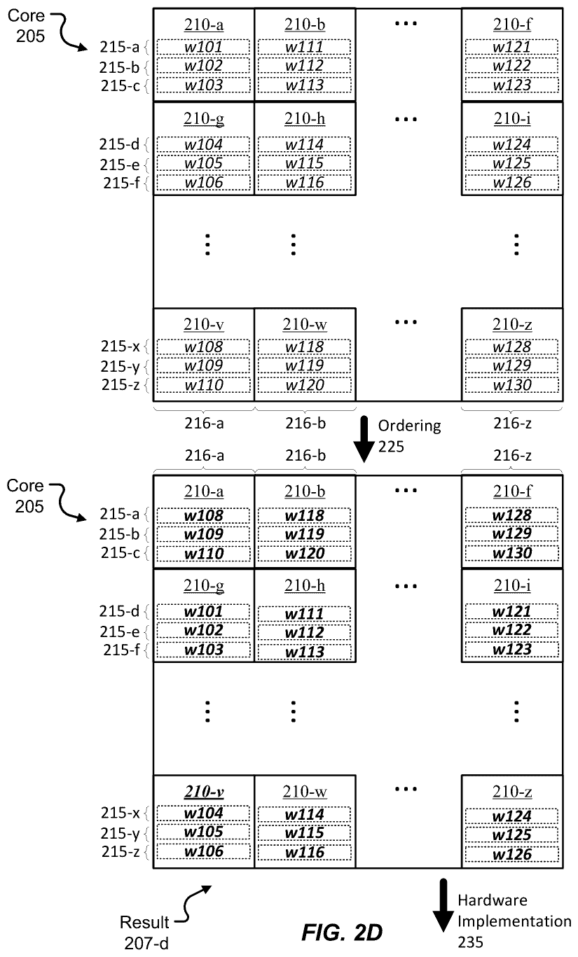

FIGS. 2A, 2B, 2C, and 2D illustrate block diagrams that support optimized weight, activation and tile mapping for HDC in AIMC in accordance with one or more embodiments of the present disclosure.

The techniques described herein may be implemented by all or a subset of the computing environment 100 of FIG. 1 (e.g., a computer 101, an end user device 103, or the like). In an embodiment, the techniques described herein described with reference to FIG. 2 may be implemented by a block 150 of FIG. 1.

According to one or more embodiments of the present disclosure, the systems and techniques described herein support ordering of weights w and activations x corresponding to rows 215 included in a core 205, prior to implementing (at 235) the core 205 in hardware, example aspects of which are described herein at least with reference to FIG. 2A. In some embodiments, the systems and techniques described herein support ordering of weights w and activations x associated with tiles 210 included in the core 205, prior to implementing (at 235) the core 205 in hardware, example aspects of which are described herein at least with reference to FIG. 2B. The core 205 may be, for example, an AIMC core described herein. FIG. 2C illustrates another example of weights w and activations x reordered in accordance with one or more embodiments of the present disclosure.

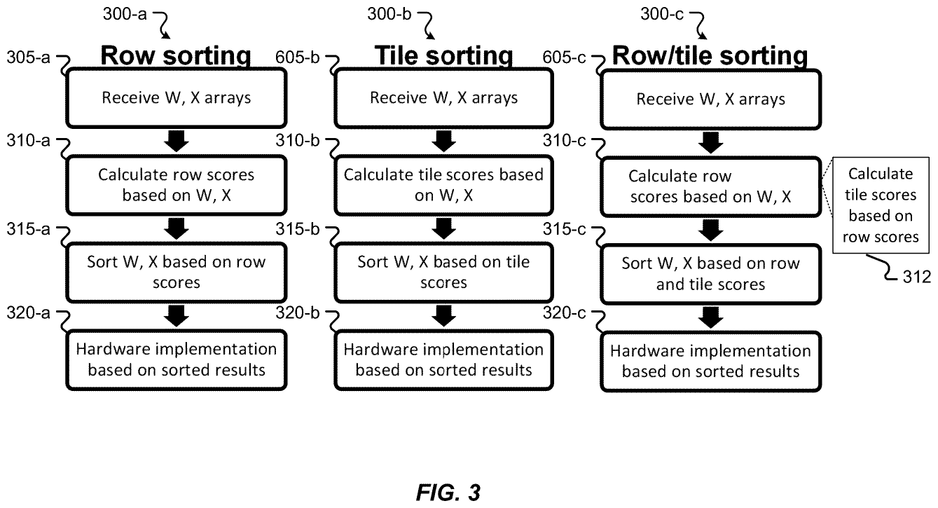

Aspects of the present disclosure support an ordering 225-a (also referred to herein as row sorting) of weights w and activations x associated with rows 215 of the core 205, an ordering 225-b (also referred to herein as tile sorting) of weights w and activations x associated with tiles 210 of the core 205, and/or an ordering (also referred to herein as row/tile sorting) of weights w and activations x associated with rows 215 and tiles 210 of the core 205, prior to implementing the core 205 in hardware at 235. Example aspects of the ordering 225-a are later described with reference to FIG. 2A, FIG. 2B, FIG. 2C, and FIG. 3. It is to be understood that references to sorting or ordering of weights w and activations x associated with tiles 210 or rows 215 may include reordering of the weights w and activations x.

Each tile 210 may include circuitry including rows 215 of resistive elements such as, for example, resistive non-volatile memory elements, phase-change memories, electrochemical memories, spin-transfer torque RAMs, resistive RAMs, conductive-bridging RAMs, and similar resistive structures. For example, each tile 210 may be a MAC structure as disclosed in U.S. Non-Provisional application Ser. No. 17/068,852 filed on Oct. 13, 2020, titled “Distributing Device Array Currents Across Segment Mirrors,” which is hereby incorporated by reference in its entirety.

In the example described with reference to FIG. 2, the core 205 may include a 512×512 array of tiles 210. However, aspects of the present disclosure are not limited thereto, and aspects of the present disclosure support reordering described herein for AIMC cores 205 of any suitable quantity of tiles.

The core 205 may be a core pre-obtained based on HDC generation and training. In an example, the core 205 may be preconfigured (based on the HDC generation and training) for machine learning tasks such as, for example, learning and classification,

According to one or more embodiments of the present disclosure, the techniques described herein support an inference implementation for re-ordering weights w and activations x corresponding to rows 215 and/or operations (e.g., multiplication, accumulation) such that the configuration of reordered weights w and activations x is different from the initial configuration of the core 205. In some embodiments, the reordering may include reshuffling of weights w and activations x while not altering mathematical operations performed by tiles 210 or rows 215 associated with the reordering. Additionally, or alternatively, in some embodiments, the reordering may include reshuffling of weights w and activations x while altering mathematical operations performed by tiles 210 or rows 215 associated with the reordering. For example, the reordering may change the operation performed by a tile 210 (e.g., tile 210-a, tile 210-g) through the shuffling of the row weight w of a given row 215 associated with a tile 210 (e.g., row 215-a of tile 210-a) to a row 215 associated with another tile 210 (e.g., to row 215-d of tile 210-g). In some aspects, the reordering may improve certain computational features of the core 205 (e.g., in a hardware implementation of the core 205).

The reordering techniques described herein may support improving the computation efficiency of the core 205. In some aspects, the reordering described herein may facilitate increased accuracy (by minimizing analog compute errors) and/or variable accuracy (e.g., allow for early termination by putting all of the most critical computation in the first tiles 210 or earlier tiles 210, potentially skipping some later tiles 210) associated with AIMC applications supported by the core 205. In some aspects, the reordering described herein may support early termination of computing operations by the core 205 (or one or more tiles 210 included in the core 205) for increased energy efficiency or throughput. That is, in accordance with example aspects of the present disclosure, a quantity of tiles 210 for completing a set of computations (based on the reordering of weights w and activations x described herein) may be less than a prior quantity of tiles 210 associated with completing the same set of computations.

In some aspects, the techniques for reordering weights w and activations x may enable a more effective early compute termination for variable precision/accuracy applications (e.g., classification) and increased energy efficiency. In some aspects, the reordering of weights w and activations x as described herein may more evenly balance currents in the tiles 210 (AIMC tiles). Accordingly, for example, the balancing of the currents may prevent or mitigate instances of saturation at one or more tiles 210, which could otherwise introduce errors into a computation performed by the one or more tiles 210.

Although the example reordering techniques are described with reference to a core 205 and in-memory compute using analog devices (e.g., AIMC), it is to be understood that the reordering techniques are not limited thereto. For example, aspects of the present disclosure support applying the reordering techniques described herein in association with designing any suitable tiled HDC architecture or DNN architecture. For example, the reordering techniques described herein support determining optimized hardware implementations for HDC. In some examples, the reordering techniques described herein support configuring the structure of a MAC for variable precision.

FIG. 3 illustrates example flowchart 300-a through flowchart 300-c in accordance with one or more embodiments of the present disclosure. The flowchart 300-a through flowchart 300-c may be implemented by the example aspects of computing environment 100 (e.g., block 150) as described herein. Operations described with reference to one or more of the flowchart 300-a through flowchart 300-c may be implemented at ordering 225 (e.g., ordering 225-a or ordering 225-b) (also referred to herein as reordering or reshuffling) of FIG. 2. For example, the ordering 225 may include any one or any combination of flowchart 300-a through flowchart 300-c. Repeated detailed descriptions of like elements included among flowchart 300-a through flowchart 300-c are omitted for brevity.

In a first example embodiment, the ordering 225 (e.g., ordering 225-a) may include flowchart 300-a (row sorting).

At 305-a (‘Receive W, X arrays’), the flowchart 300-a may include receiving array information for core 205. For example, the array information may indicate that the core 205 includes an array of weights w and activations x corresponding to rows 215 of the core 205. For example, the array information may include a weight w and an activation x, for each tile 210 of each row 215. The array information may include a cumulative weight w (e.g., weight w1 through weight w10) for each row 215.

At 310-a (‘Calculate row scores based on W, X’), the flowchart 300-a may include calculating scores for one or more rows 215. In an example, the scores may include one or more row metrics respective to the rows 215, and 310-a may include indexing the rows 215 according to the scores.

In some embodiments, the flowchart 300-a may include calculating scores s for each row 215. In some embodiments, the flowchart 300-a may include calculating scores s for one or more rows 215 according to an order (e.g., row 215-a, row 215-b, . . . ).

In an example, calculating the score s for a given row 215 may be based on weights w and activations x associated with the row 215. In some embodiments, the flowchart 300-a may include calculating the scores s using one or more example equations (e.g., Equation (1), Equation (2), Equation (3), Equation (4), or the like) later described herein.

At 315-a (‘Sort W, X based on row scores), the flowchart 300-a may include sorting or ordering the weights w and activations x based on the respective scores of the rows 215. For example, 315-a may include sorting or ordering the weights w and activations x based on the respective row metrics (e.g., scores s) of the rows 215. In some examples, the row metrics of a given row 215 may include a metric (e.g., score s) of the row 215, based on a cumulative metric or mean value of the metric among tiles 210 associated with the row 215.

At 320-a (‘Hardware implementation based on sorted results’) (and 235 of FIG. 2A), the flowchart 300-a may include implementing the core 205 in hardware based on the sorting results.

In a second example embodiment, the ordering 225 (e.g., ordering 225-b) may include flowchart 300-b (tile sorting).

At 305-b (‘Receive W, X arrays’), the flowchart 300-b may include receiving array information for core 205. For example, the array information may include aspects of the array information described with reference to 305-a.

At 310-b (‘Calculate tile scores based on W, X’), the flowchart 300-b may include calculating scores for one or more tiles 210. In an example, the scores may include one or more tile metrics respective to the tiles 210, and 310-b may include indexing the tiles 210 according to the scores.

In an example, calculating the score for a given tile 210 may be based on weights w associated with rows 215 included in the tile 210 and activations x associated with the tile 210. For example, with reference to FIG. 2B, tile 210-a may include row 215-a through row 215-c. The flowchart 300-b may include calculating a score for tile 210-a based on weights w1 through w3 (respectively associated with row 215-a through row 215-c) and activations x associated with tile 210-a.

In some embodiments, the score for a given tile 210 may be based on an accuracy associated with the tile 210.

At 315-b (‘Sort W, X based on row scores’), the flowchart 300-b may include sorting or ordering the weights w and activations x based on the respective scores of the tiles 210. For example, 315-b may include sorting or ordering weights w and activations x based on the respective tile metrics of the tiles 210.

In some embodiments, 315-b of the flowchart 300-a may include sorting or ordering weights w and activations x associated with tiles 210 until a target criteria is met. In an example, 315-b may include sorting or ordering weights w and activations x according to respective accuracies of the tiles 210 (e.g., from highest accuracy to lowest accuracy).

At 320-b (‘Hardware implementation based on sorted results), the flowchart 300-b may include implementing the core 205 in hardware based on the sorting results.

In a third example embodiment, the ordering 225 may include flowchart 300-c (row/tile sorting).

At 305-c (‘Receive W, X arrays’), the flowchart 300-c may include receiving array information for core 205. For example, the array information may include aspects of the array information described with reference to 305-a.

At 310-c (‘Calculate row scores based on W, X’), the flowchart 300-c may include calculating scores for each row 215. In an example, the scores may include the row metrics described with reference to flowchart 300-a.

At 310-c, the flowchart 300-c may include indexing the rows 215 according to respective scores of the rows 215. Calculating the row scores at 310-c and indexing the rows 215 may include aspects described with reference to 310-a, and repeated descriptions of like elements are omitted for brevity.

At 312 (‘Calculate tile scores based on row scores’), the flowchart 300-c may include calculating scores for each tile 210 (e.g., tile 210-a, tile 210-b, tile 210-f, and the like) based on the row scores of rows 215 (e.g., rows 215-a through 215-c) included in the tile 210. For example, 312 may include calculating the tile score of a tile 210 (e.g., tile 210-a) as a function of the row scores of rows (e.g., rows 215-a through 215-c) associated with the tile 210. Accordingly, for example, at 312, the flowchart 300-c may include calculating a tile metric for each tile 210.

At 315-c (‘Sort W, X based on row and tile scores), the flowchart 300-c may include sorting or ordering the weights w and activations x based on the respective scores of the rows 215 and the tiles 210. For example, the flowchart 300-c may include sorting or ordering weights w and activations x based on the respective scores (calculated at 310-c) of the rows 215 and the respective scores (calculated at 312-c) of the tiles 210. The flowchart 300-c may then further include sorting or ordering the weights w and activations x based on the respective scores of the rows 215 and the respective scores of the tiles 210.

At 320-c (‘Hardware implementation based on sorted results), the flowchart 300-c may include implementing the core 205 in hardware based on the sorting results.

Referring to FIG. 2A, an example result 207-a achievable by the techniques described herein (e.g., by any of flowchart 300-a through 300-c) is illustrated. At FIG. 2A, weights w1 through w3 originally associated with row 215-a through row 215-c have been have been reordered, weights w5 and w6 originally associated with row 215-e through row 215-f have been have been reordered, and weights (e.g., weight w4, weight w8, weight w9, weight w10) associated with remaining rows have been maintained. Example aspects of the row metrics are later described herein, for example, with reference to Equation (3).

Referring to FIG. 2B, an example result achievable by the techniques described herein (e.g., by any of flowchart 300-a through 300-c) is illustrated. At FIG. 2B, weights w101 through w110 originally associated with tiles 210 of column 216-a (e.g., tile 210-a, tile 210-g, tile 210-v, and intervening tiles between tile 210-g and tile 210-v in the vertical direction) have been relocated to tiles 210 of column 216-b (e.g., tile 210-b, tile 210-h, tile 210-w, and intervening tiles between tile 210-h and tile 210-w in the vertical direction), weights w111 through w120 originally associated with tiles 210 of column 216-b (e.g., tile 210-b, tile 210-h, tile 210-w, and intervening tiles between tile 210-h and tile 210-w in the vertical direction) have been relocated to tiles 210 of column 216-a (e.g., tile 210-a, tile 210-g, tile 210-v, and intervening tiles between tile 210-g and tile 210-v in the vertical direction). In the example, weights w121 through w130 originally associated with tiles 210 of column 216-z (e.g., tile 210-f, tile 210-k, tile 210-z, and intervening tiles between tile 210-k and tile 210-z in the vertical direction) have been maintained. Example aspects of the tile metrics are later described herein.

As illustrated at FIG. 2B, cumulative row weights w1 through w10 originally associated with row 215-a through row 215-z have been have been maintained.

FIG. 2C illustrates is another example result 207-c achievable by the techniques described herein (e.g., by any of flowchart 300-a through 300-c). Referring to FIG. 2C, the example result 207-c is similar to the example result 207-b of FIG. 2B, with a further reordering in that weight 102 through w122 (originally associated with row 215-b) are newly associated with row 215-c and weight 103 through w123 (originally associated with row 215-c) are newly associated with row 215-b.

FIG. 2D illustrates is another example result 207-d achievable by the techniques described herein (e.g., by any of flowchart 300-a through 300-c). At FIG. 2D, an example of tile shuffling is indicated, in which the order of the tiles 210 is changed in the vertical direction.

For example, weights w101 through w103 originally associated with tile 210-a have been relocated to tile 210-g, weights w111 through w113 originally associated with tile 210-b have been relocated to tile 210-h, and weights w121 through w123 originally associated with tile 210-f have been relocated to tile 210-i. Weights w104 through w106 originally associated with tile 210-g have been relocated to tile 210-w, weights w114 through w116 originally associated with tile 210-h have been relocated to tile 210-w, and weights w124 through w126 originally associated with tile 210-i have been relocated to tile 210-z. Weights w108 through w110 originally associated with tile 210-v have been relocated to tile 210-a, weights w118 through w120 originally associated with tile 210-w have been relocated to tile 210-b, and weights w128 through w130 originally associated with tile 210-z have been relocated to tile 210-f.

The techniques described herein support reordering of tiles 210 (e.g., reassigning of weights) in terms of significance of operations performed at particular tiles 210. For example, the reordering techniques described with reference to FIG. 2D illustrate an example of improving the computation efficiency of the core 205 by reallocating weights.

In the example, tile 210-a through tile 210-f (tile 210-c and tile 210-d are not illustrated) have a lowest accuracy among tiles 210 included in the core 205, and the techniques described herein include reallocating lowest weights (e.g., weights w108 through w110, weights w118 through w120, and weights w128 through w130, and weights associated with tile 210-x and tile 210-y (not illustrated)) to tile 210-a through tile 210-f.

Tile 210-v through tile 210-z have a highest accuracy among tiles 210 included in the core 205, and the techniques described herein include reallocating highest weights (e.g., weights w104 through w106, weights w114 through w116, and weights w124 through w126, and weights associated with tile 210-i and tile 210-j (not illustrated)) to tile 210-v through tile 210-z.

In an example, based on the reallocated weights, tile 210-v through tile 210-z may perform respective computations first, followed by other tiles 210 in order of decreasing weights. In some cases, based on the computation order, tile 210-v through tile 210-z and the other tiles 210 may fully complete computations to be performed by the core 205 such that computations at tile 210-a through tile 210-f may be skipped.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

Accordingly, for example, flowchart 300-c supports dual/simultaneous optimization across rows 215 and/or tiles 210. The techniques described herein for ordering weights w and activations x among rows 215 (or both rows 215 and tiles 210) may support increasing the distribution of loads (e.g., evenly distributing loads) across each row 215 and/or tile 210. Accordingly, for example, the techniques described herein support single and dual optimization.

Examples of the tile metrics and row metrics supportive of tile ordering and row ordering in accordance with aspects of the present disclosure are now described herein. The techniques described herein support terminating multiply accumulate (MAC) operations after the summation of some fraction of the tiles 210.

According to one or more embodiments of the present disclosure, the row metric described with reference to flowchart 300-a and flowchart 300-c may be a mean row weight w according to Equation (1). The terms ‘row metric’ and ‘row score’ may be used interchangeably herein.

$${s}_{i} = {\sum }_{j = 0}^{J} {w}_{ij} \qquad ( 1 )$$

With reference to Equation (1), w=weight, i=spatial row, and j=spatial column. In some aspects, as weights may be static, scoring and ordering the rows 215 according to respective weights w may be less computationally expensive compared to other techniques described herein.

According to one or more embodiments of the present disclosure, the row metric may be based on the applied activations x corresponding to the rows 215 according to Equation (2).

$${s}_{i} = {\sum }_{k = 0}^{K} {x}_{ik} \qquad ( 2 )$$

In some aspects, as activations may vary, scoring and ordering the rows 215 according to respective activations x may provide additional or alternative scoring and ordering in exchange for additional computational expense.

According to one or more embodiments of the present disclosure, the row metric may be based on a combination of row weights w and corresponding activations corresponding to the rows 215 according to Equation (3).

$${s}_{i} = {\sum }_{j = 0}^{J} {w}_{ij} {\sum }_{k = 0}^{K} {x}_{ik} \qquad ( 3 )$$

In some aspects, ordering the rows 215 according to row weights w and corresponding activations x may provide increased scoring and ordering effectiveness in exchange for additional computational expense.

According to one or more embodiments of the present disclosure, the row metric may be based on a combination of row weights w and corresponding activations x according to a generalized Equation (4).

$${s}_{i} = f ( {w}_{ij} , {x}_{ik} ) \qquad ( 4 )$$

With reference to Equation (4), i=spatial, j is spatial, k is time.

According to one or more embodiments of the present disclosure, the quantity of tiles 210 reordered by the techniques described herein in comparison to the total quantity of tiles 210 of a core 205 (i.e., the fraction of the tiles 210) may be relatively large, but less than all the tiles 210, in accordance with Equation (5).

$${z}_{j} = {\sum }_{t = 0}^{T} {z}_{tj} \qquad ( 5 )$$

With reference to Equation (5), z is output activation, and Tis some quantity of tiles 210.

An example embodiment of dual/simultaneous optimization across rows 215 and tiles 210 is described herein in which row score is based on weight, according to Equation (1) above and the example details below.

$$sorted\_inds = arg sort ( {s}_{i} )$$

$$index\_array = [ sorted\_inds [ \text{?} T ] for i in range ( T ) ] = 2 D matrix will with index values = \begin{matrix}[ … ] \\ [ … ] \\ [ … ]\end{matrix}$$

$$\text{?} {\underbrace{{\sum }_{k = 0}^{K} {\underbrace{{\underbrace{arg max {\underbrace{( \text{?} {x}_{ik} {w}_{ij} )}}_{{z}_{j} = MAC outputs}}}_{class} == {\underbrace{class [ k ]}}_{true class}}}_{correct class}}}_{accuracy} ,$$

$$\text{?} \text{indicates text missing or illegible when filed}$$

where i=spatial row, j=spatial column, k=time (for activations), t is the quantity of tiles.

In an example implementation, optimization of the ordering of a core 205 using dual/simultaneous optimization across rows 215 and tiles 210 (e.g., in accordance with flowchart 300-c described herein) may include optimizing the accuracy of a first tile 210. The optimization of the ordering may include repeating the following tile 210 (e.g., select a next best set of rows 215 without replacement or reordering of tiles 210).

As presented herein, aspects of a method, apparatus, and system for ordering (reordering) weights and activations in software before AIMC hardware implementation of HDC are described. In some aspects, rows are indexed according to one or more row metrics. In some aspects, tiles are indexed according to one or more tile metrics. In some aspects, rows are re-ordered according to the row metric. In some aspects, the techniques described herein support reordering tiles according to the one or more tile metrics. In some aspects, the techniques described herein may include terminating MAC operations after the summation of a fraction of the tiles.

In some embodiments, the row metric is a mean row weight described at least with reference to Equation (1) herein. In some embodiments, the row metric is based on the applied activations described at least with reference to Equation (2) herein. In some embodiments, the row metric is a combination of row weights and corresponding activations as described at least with reference to Equation (3) herein. In some embodiments, the row metric is a combination of row weights and corresponding activations as described at least with reference to Equation (4) herein. In some embodiments, the fraction of the tiles is greater than one but less than all the tiles, as described at least with reference to Equation (5) herein.

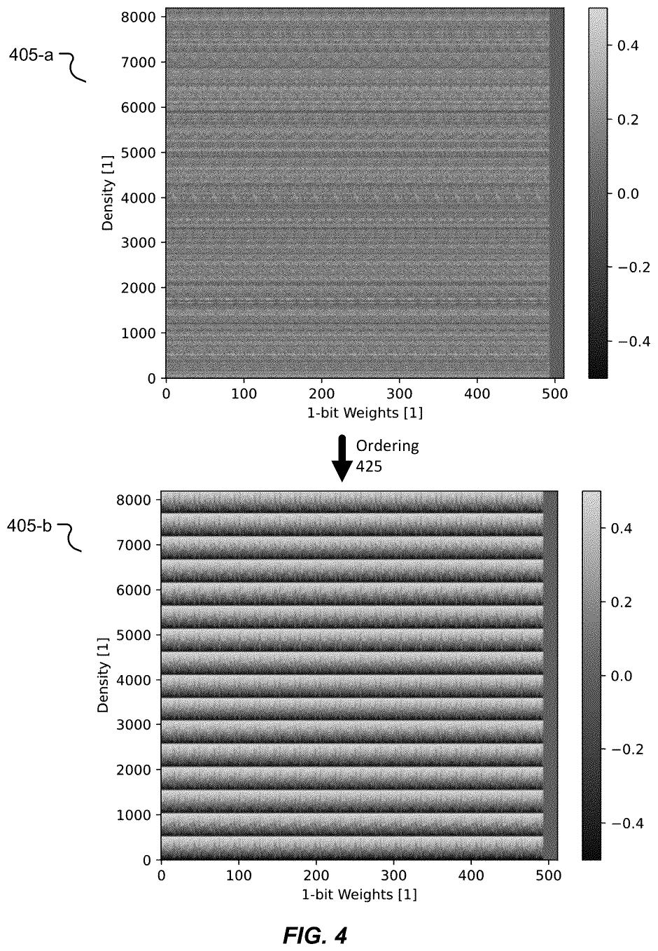

FIG. 4 is a diagram 400 illustrating an example structure of a core 405-a prior to ordering 425 (e.g., row and/or tile ordering) and an example structure of the resulting core 405-b, in accordance with example aspects of the present disclosure.

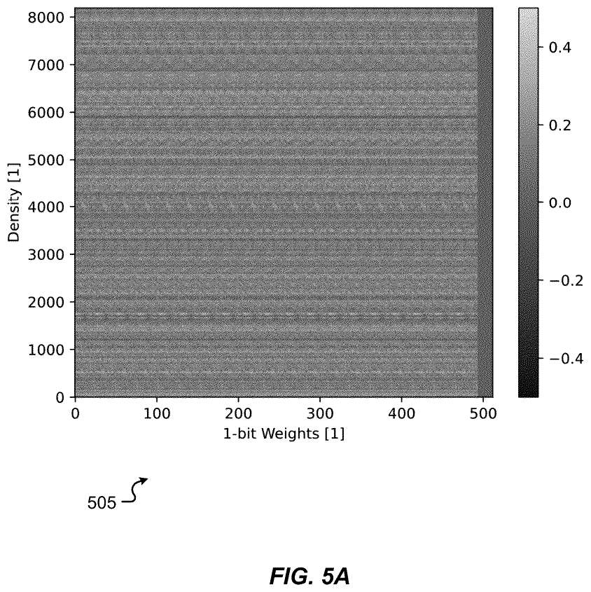

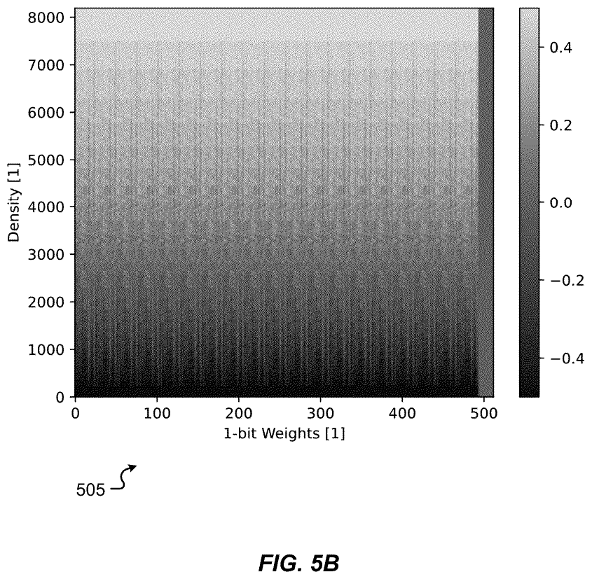

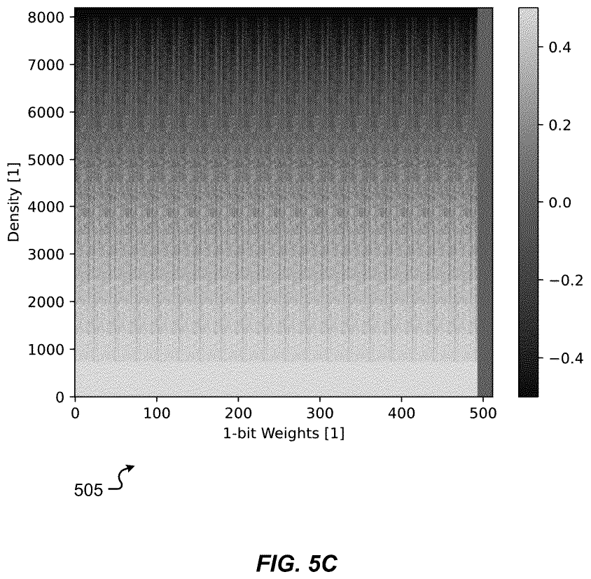

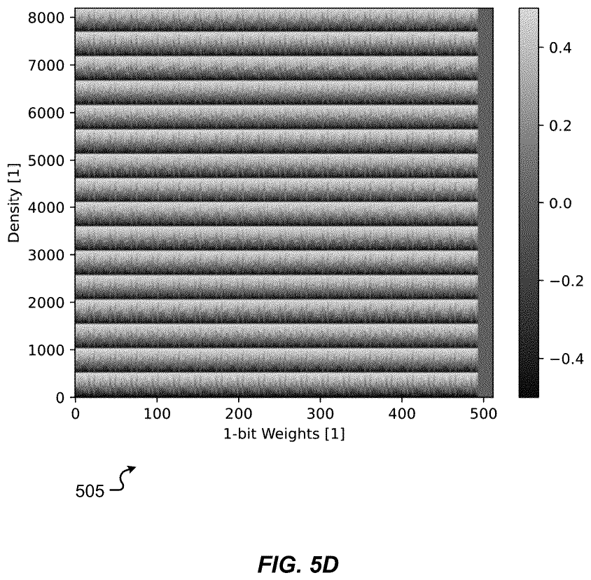

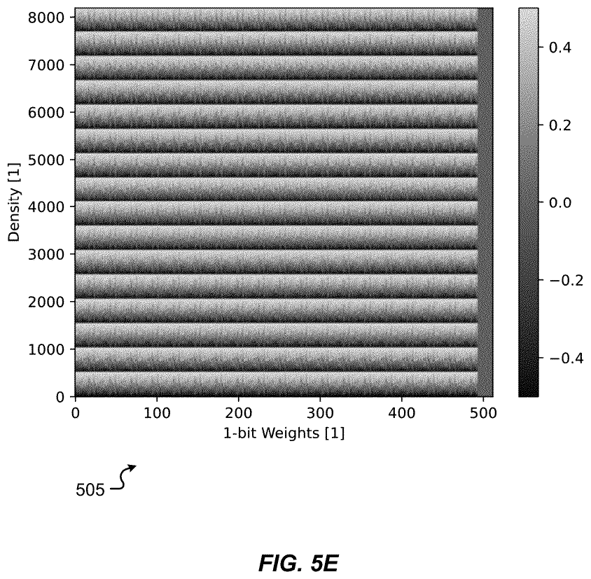

FIG. 5A is a diagram illustrating an example unsorted weight matrix of a core 505 based on row ordering and/or tile ordering in accordance with example aspects of the present disclosure.

FIG. 5B is a diagram illustrating an example sorted weight matrix (low to high by mean row value) of the core 505 based on row ordering and/or tile ordering in accordance with example aspects of the present disclosure.

FIG. 5C is a diagram illustrating an example sorted weight matrix (high to low by mean row value) of the core 505 based on row ordering and/or tile ordering in accordance with example aspects of the present disclosure.

FIG. 5D is a diagram illustrating an example sorted weight matrix (evenly dispersed across tiles by mean row value) of the core 505 based on row ordering and/or tile ordering in accordance with example aspects of the present disclosure. In the example of FIG. 5D, AIMC hardware currents are more balanced.

FIG. 5E is a diagram illustrating an example sorted weight matrix (evenly dispersed across tiles by mean row value) of the core 505 based on row ordering and/or tile ordering in accordance with example aspects of the present disclosure. In the example of FIG. 5E, AIMC hardware currents are more balanced, and tiles have been reordered (reshuffled) from highest accuracy to lowest.

According to one or more embodiments of the present disclosure, the weights described herein can be programmed in analog memory as 1-bit, 2-bit, or 3-bit equivalents or continuously. For example, the examples described with reference to FIG. 4 and FIGS. 5A through 5E are weight matrices according to 1-bit weights.

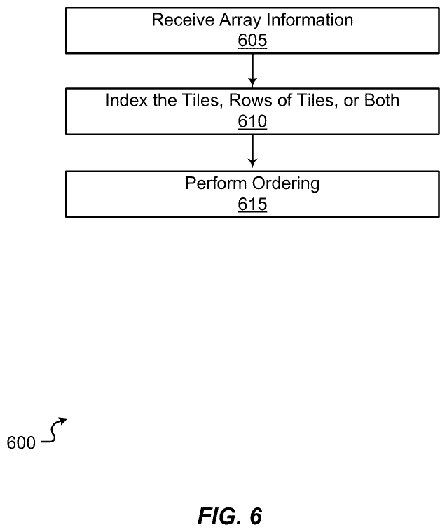

FIG. 6 illustrates an example flowchart of a method 600 in accordance with one or more embodiments of the present disclosure.

At 605, the method 600 includes receiving array information associated with a processing core, the processing core comprising a plurality of tiles configured for performing one or more MAC operations.

At 610, the method 600 includes indexing the tiles, rows of the tiles, or both according to one or more metrics.

At 615, the method 600 includes performing an ordering based on the one or more metrics, wherein the ordering includes at least one of: an ordering of weights respectively associated with the rows; and an ordering of weights respectively associated with the tiles.

In some aspects, the ordering of the weights respectively associated with the rows includes reassigning a row weight associated with a row of circuitry included in a set of tiles to another row of circuitry included in the set of tiles.

In some aspects, the ordering of the weights respectively associated with the rows includes reassigning a row weight associated with a row of circuitry included in a set of tiles to a row of circuitry included in another set of tiles.

In some aspects, the ordering of the weights respectively associated with the tiles includes reassigning at least one weight associated with a tile included in the plurality of tiles to another tile included in the plurality of tiles.

In some aspects, the tile and the other tile are included in a subset of tiles included in the plurality of tiles.

In some aspects, the ordering includes an ordering of activations respectively associated with the rows, wherein the ordering of the activations includes: reassigning a set of activations associated with a row of circuitry included in a set of tiles to another row of circuitry included in the set of tiles; or reassigning the set of activations to a row of circuitry included in another set of tiles.

In some aspects, the ordering includes an ordering of activations respectively associated with the tiles, wherein the ordering of the activations includes: reassigning a set of activations associated with a tile included in the plurality of tiles to another tile included in the plurality of tiles.

In some aspects, the tile and the other tile are included in a subset of tiles included in the plurality of tiles.

In some aspects, the one or more metrics include one or more row metrics. In some aspects, indexing the tiles, the rows of the tiles, or both includes indexing the rows according to the one or more row metrics.

In some aspects, the one or more metrics include one or more row metrics. In some aspects, the method 600 further includes calculating one or more tile metrics based on the one or more row metrics, wherein indexing the tiles, the rows of the tiles, or both includes indexing the tiles according to the one or more tile metrics.

In some aspects, the one or more row metrics include a mean weight of each of the rows.

In some aspects, the one or more row metrics are based on one or more applied activations respectively associated with each of the rows.

In some aspects, the one or more row metrics are based on: a mean weight of each of the rows; and one or more applied activations respectively associated with each of the rows.

In some aspects, each tile of the plurality of tiles includes an array of resistive elements.

In some aspects, the processing core includes an AIMC core.

In some aspects, the method 600 includes executing a simulation environment including the processing core, wherein at least one of receiving the array information for the processing core, indexing the tiles, the rows of the tiles, or both, and performing the ordering is performed in the simulation environment.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

Terms such as, for example, first, second, and the like may be used to describe various components, but the components should not be limited by the terms. The terms as used herein may distinguish one component from other components and are not to be limited by the terms. For example, without departing the scope of the present disclosure, a first component may be referred to as a second component, and similarly, the second component may also be referred to as the first component.

Various embodiments are described herein with reference to the related drawings Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving array information associated with a processing core, the processing core comprising a plurality of tiles configured for performing one or more multiply-accumulate (MAC) operations;
indexing the tiles, rows of the tiles, or both according to one or more metrics; and
performing an ordering based on the one or more metrics, wherein the ordering comprises at least one of:
an ordering of weights respectively associated with the rows; and
an ordering of weights respectively associated with the tiles.

2. The computer-implemented method of claim 1, wherein the ordering of the weights respectively associated with the rows comprises reassigning a row weight associated with a row of circuitry included in a set of tiles to another row of circuitry included in the set of tiles.

3. The computer-implemented method of claim 1, wherein the ordering of the weights respectively associated with the rows comprises reassigning a row weight associated with a row of circuitry included in a set of tiles to a row of circuitry included in another set of tiles.

4. The computer-implemented method of claim 1, wherein the ordering of the weights respectively associated with the tiles comprises reassigning at least one weight associated with a tile included in the plurality of tiles to another tile included in the plurality of tiles.

5. The computer-implemented method of claim 4, wherein the tile and the other tile are included in a subset of tiles included in the plurality of tiles.

6. The computer-implemented method of claim 1, wherein the ordering comprises an ordering of activations respectively associated with the rows, wherein the ordering of the activations comprises:
reassigning a set of activations associated with a row of circuitry included in a set of tiles to another row of circuitry included in the set of tiles; or
reassigning the set of activations to a row of circuitry included in another set of tiles.

7. The computer-implemented method of claim 1, wherein the ordering comprises an ordering of activations respectively associated with the tiles, wherein the ordering of the activations comprises:
reassigning a set of activations associated with a tile included in the plurality of tiles to another tile included in the plurality of tiles.

8. The computer-implemented method of claim 7, wherein the tile and the other tile are included in a subset of tiles included in the plurality of tiles.

9. The computer-implemented method of claim 1, wherein:
the one or more metrics comprise one or more row metrics; and
indexing the tiles, the rows of the tiles, or both comprises indexing the rows according to the one or more row metrics.

10. The computer-implemented method of claim 1, wherein:
the one or more metrics comprise one or more row metrics; and
the method further comprises calculating one or more tile metrics based on the one or more row metrics,
wherein indexing the tiles, the rows of the tiles, or both comprises indexing the tiles according to the one or more tile metrics.

11. The computer-implemented method of claim 1, wherein the one or more row metrics comprise a mean weight of each of the rows.

12. The computer-implemented method of claim 1, wherein the one or more row metrics are based on one or more applied activations respectively associated with each of the rows.

13. The computer-implemented method of claim 1, wherein the one or more row metrics are based on:
a mean weight of each of the rows; and
one or more applied activations respectively associated with each of the rows.

14. The computer-implemented method of claim 1, wherein each tile of the plurality of tiles comprises an array of resistive elements.

15. The computer-implemented method of claim 1, wherein the processing core comprises an analog in-memory computing (AIMC) core.

16. The computer-implemented method of claim 1, further comprising:
executing a simulation environment comprising the processing core,
wherein at least one of receiving the array information for the processing core, indexing the tiles, the rows of the tiles, or both, and performing the ordering is performed in the simulation environment.

2. A computing system having a memory having computer readable instructions and one or more processors for executing the computer readable instructions, the computer readable instructions controlling the one or more processors to perform operations comprising:
receiving array information associated with a processing core, the processing core comprising a plurality of tiles configured for performing one or more multiply-accumulate (MAC) operations;
indexing the tiles, rows of the tiles, or both according to one or more metrics; and
performing an ordering based on the one or more metrics, wherein the ordering comprises at least one of:
an ordering of weights respectively associated with the rows; and
an ordering of weights respectively associated with the tiles.

18. The computing system of claim 17, wherein the computer readable instructions controlling the one or more processors to perform the ordering of the weights respectively associated with the rows control the one or more processors to further perform operations comprising reassigning a row weight associated with a row of circuitry included in a set of tiles to another row of circuitry included in the set of tiles.

19. The computing system of claim 17, wherein the computer readable instructions controlling the one or more processors to perform the ordering of the weights respectively associated with the rows control the one or more processors to further perform operations comprising reassigning a row weight associated with a row of circuitry included in a set of tiles to a row of circuitry included in another set of tiles.

3. A computer program product comprising a computer readable storage medium having program instructions embodied therewith, the program instructions executable by a processor to cause the processor to perform operations comprising:
receiving array information associated with a processing core, the processing core comprising a plurality of tiles configured for performing one or more multiply-accumulate (MAC) operations;
indexing the tiles, rows of the tiles, or both according to one or more metrics; and
performing an ordering based on the one or more metrics, wherein the ordering comprises at least one of:
an ordering of weights respectively associated with the rows; and
an ordering of weights respectively associated with the tiles.
